(19) United States
(12) Patent Application Publication
(10) Pub. No.: US 2026/0075171 A1
(43) Pub. Date: Mar. 12, 2026

(54) LASER PROJECTION DEVICE AND METHOD FOR IMAGE DISPLAY

(71) Applicant: HISENSE LASER DISPLAY CO., LTD, Qingdao (CN)

(72) Inventors: Yishi ZHAO, Qingdao (CN); Zhiyuan LI, Qingdao (CN); Jichen XIAO, Qingdao (CN); Libo GAO, Qingdao (CN); Xinjian ZHANG, Qingdao (CN)

(21) Appl. No.: 19/389,328

(22) Filed: Nov. 14, 2025

Related U.S. Application Data
(63) Continuation of application No. PCT/CN2024/102066, filed on Jun. 27, 2024.

(30) Foreign Application Priority Data
Aug. 21, 2023 (CN) 202311056608.1
Aug. 21, 2023 (CN) 202311056611.3

(51) Int. Cl. H04N 9/31; G03B 21/00; G03B 21/20

(52) U.S. Cl. CPC H04N 9/3161; G03B 21/008; G03B 21/2013; G03B 21/2033; H04N 9/3102

(57) ABSTRACT

A display drive assembly sends an enable signal and a Pulse Width Modulation (PWM) signal to a laser drive assembly based on a video signal, sends the enable signal to a phase light modulation assembly, and sends a display drive signal to a light modulator. The laser drive assembly sends a light source drive signal to a light source assembly based on the enable signal and the PWM signal, in order to drive the light source assembly to emit one of multiple primary color lights. A video processing assembly sends a phase video signal to the phase light modulation assembly based on the video signal. The phase light modulation assembly performs phase light modulation based on the phase video signal and the enable signal, in order to transmit a modulated light to the light modulator.

### CROSS-REFERENCE TO RELATED APPLICATIONS

The present application is a continuation application of International Patent Application No. PCT/CN2024/102066, filed on Jun. 27, 2024, which claims priority to Chinese Patent Application No. 202311056608.1, filed on Aug. 21, 2023, and Chinese Patent Application No. 202311056611.3, filed on Aug. 21, 2023. The entire disclosures of the aforementioned applications are hereby incorporated herein by reference.

### TECHNICAL FIELD

The present disclosure generally relates to the field of display technology, and more particularly, to a laser projection device and a method for image display.

### BACKGROUND

Laser projection display is a new generation of display technology, which utilizes laser as the light source and Digital Light Processing (DLP) technology for image projection. A laser projection device has advantages of energy saving, eye protection, bright color, and so on.

### SUMMARY

A laser projection device and a method for image display are provided by the present disclosure. Technical solutions of the laser projection device and the method for the image display are described as follows.

In a first aspect, the laser projection device is provided by the present disclosure. The laser projection device may include a main control chip, a display drive assembly, a light modulator, a light source assembly, and a laser drive assembly. The main control chip is configured to generate a video signal based on an external video source. The display drive assembly is connected to the laser drive assembly and the light modulator respectively, and the display drive assembly is configured to obtain the video signal, send an enable signal and a Pulse Width Modulation (PWM) signal to the laser drive assembly based on the video signal, and send a display drive signal to the light modulator based on the video signal. The laser drive assembly is connected to the light source assembly, and the laser drive assembly is configured to send a light source drive signal to the light source assembly based on the enable signal and the PWM signal, in order to drive the light source assembly to light up and emit one of multiple primary color lights. The laser projection device may further include a phase light modulation assembly and a video processing assembly. The video processing assembly is connected to the main control chip and the phase light modulation assembly, respectively, and the video processing assembly is configured to send a phase video signal to the phase light modulation assembly based on the video signal. The display drive assembly is connected to the phase light modulation assembly, and the display drive assembly is further configured to send the enable signal to the phase light modulation assembly. The phase light modulation assembly is configured to perform phase light modulation based on the phase video signal and the enable signal to transmit a modulated light to the light modulator. The light modulator is configured to transmit modulation light based on the modulated light, and the modulation light is configured to form an image beam.

In a second aspect, the method for the image display of the laser projection device is provided by the present disclosure. The laser projection device may include a main control chip, a display drive assembly, a light modulator, a light source assembly, a laser drive assembly, a phase light modulation assembly, and a video processing assembly. The display drive assembly is connected to the laser drive assembly, the light modulator, and the phase light modulation assembly, respectively. The laser drive assembly is connected to the light source assembly. The video processing assembly is connected to the main control chip and the phase light modulation assembly, respectively. The method may include: by the display drive assembly, a video signal is acquired, an enable signal and a Pulse Width Modulation (PWM) signal are sent to the laser drive assembly based on the video signal, the enable signal is sent to the phase light modulation assembly, and a display drive signal is sent to the light source assembly; by the laser drive assembly, a light source drive signal is sent to the light source assembly based on the enable signal and the PWM signal, in order to drive the light source assembly to light up and emit one of multiple primary color lights; by the video processing assembly, a phase video signal is sent to the phase light modulation assembly based on the video signal; by the phase light modulation assembly, phase light modulation is performed based on the phase video signal and the enable signal to transmit the modulated light to the light modulator; and by the light modulator, a modulation light is transmitted based on the modulated light.

### BRIEF DESCRIPTION OF THE DRAWINGS

FIG. 1 is a schematic structural diagram illustrating a laser projection device according to an embodiment of the present disclosure.

FIG. 2 is a schematic diagram illustrating backlight local adjustment according to an embodiment of the present disclosure.

FIG. 3 is a schematic diagram illustrating implementation of local backlight adjustment by combining a phase light modulator with a multi-segment light modulator according to an embodiment of the present disclosure.

FIG. 4 is a schematic diagram illustrating another backlight local adjustment according to an embodiment of the present disclosure.

FIG. 5 is a schematic diagram illustrating implementation of local backlight adjustment by combining a monolithic phase light modulator with a monolithic light modulator according to an embodiment of the present disclosure.

FIG. 6 is a schematic diagram illustrating implementation of local backlight adjustment by combining a monolithic phase light modulator with a light modulator according to an embodiment of the present disclosure.

FIG. 7 is a schematic structural diagram of a laser projection device provided according to an embodiment of the present disclosure.

FIG. 8 is a schematic structural diagram of a video processing assembly provided according to an embodiment of the present disclosure.

FIG. 9 is a schematic structural diagram of another video processing assembly provided according to an embodiment of the present disclosure.

FIG. 10 is a schematic structural diagram of another laser projection device provided according to an embodiment of the present disclosure.

FIG. 11 is a schematic diagram illustrating synchronization among a light source, phase modulation, and display according to an embodiment of the present disclosure.

FIG. 12 is a schematic structural diagram of a phase light modulation assembly provided according to an embodiment of the present disclosure.

FIG. 13 is a schematic structural diagram of a bias voltage conversion circuit provided according to an embodiment of the present disclosure.

FIG. 14 is a schematic structural diagram of another bias voltage conversion circuit provided according to an embodiment of the present disclosure.

FIG. 15 is a schematic diagram illustrating waveforms of an enable signal and a bias voltage according to an embodiment of the present disclosure.

FIG. 16 is a schematic diagram illustrating, in presence of a delay, adjustment of a timing delay of enable signals corresponding to multiple primary color lights according to an embodiment of the present disclosure.

FIG. 17 is a schematic diagram illustrating a bias voltage signal without and with the first voltage signal superimposed according to an embodiment of the present disclosure.

FIG. 18 is a schematic diagram illustrating waveforms of a bias voltage signal superimposed on a first voltage signal and an enable signal according to an embodiment of the present disclosure.

FIG. 19 is a schematic diagram illustrating a first brightness correction parameter and an image area according to an embodiment of the present disclosure.

FIG. 20 is a schematic diagram illustrating a target matrix according to an embodiment of the present disclosure.

FIG. 21 is a schematic flow of an image display method for a laser projection device provided according to an embodiment of the present disclosure.

### DETAILED DESCRIPTION

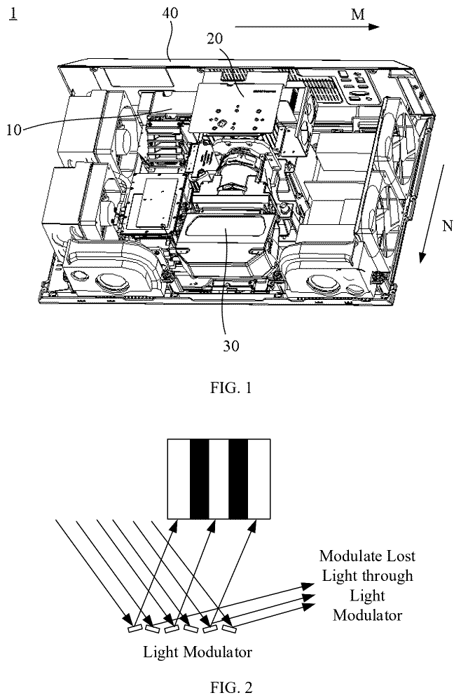

FIG. 1 is a schematic structural diagram of a laser projection device provided according to an embodiment of the present disclosure. Referring to FIG. 1, the laser projection device 1 (or called laser television) may include a light source 10, a light modulation assembly 20, a lens 30, and a housing 40 (the housing 40 is partially shown in FIG. 1). The light modulation assembly 20 may include a light modulator 103 and a phase light modulation assembly 107 described below.

The light source 10 is configured to provide an illumination beam (laser beam). The light modulation assembly 20 is configured to modulate the illumination beam provided by the light source 10 to obtain a projected beam by using an image signal. The lens 30 is configured to project the projected beam onto a screen or a wall to form a projection image. The light source 10, the light modulation assembly 20, and the lens 30 are assembled in the housing 40. The light source 10, the light modulation assembly 20, and the lens 30 may be connected in turn along a beam propagation direction.

The light source 10, the light modulation assembly 20, and the lens 30 may be wrapped by corresponding housings, respectively. The housings corresponding to the light source 10, the light modulation assembly 20, and the lens 30, respectively, may support corresponding light components and make each of the light components meet certain sealing or air-tightness requirements.

One end of the light modulation assembly 20 is connected to the lens 30, and the light modulation assembly 20 and the lens 30 are set along an output direction of the projected beam (e.g., parallel to N direction) of the laser projection device 1. Another end of the light modulation assembly 20 may be connected to the light source 10.

In a possible implementation, an arrangement direction of the light source 10 and the light modulation assembly 20 is roughly perpendicular to an arrangement direction of the light modulation assembly 20 and the lens 30. That is, in the laser projection device 1, an exit direction (e.g., parallel to the N direction) of the projected beam is roughly perpendicular to an exit direction (e.g., parallel to M direction) of the illumination beam.

When the laser projection device is used for projection display, due to limitations of a light source form, the laser projection device may not be able to adjust brightness of lamp beads by dividing into different regions to achieve local adjustment of the backlight and High-Dynamic Range (HDR) display as the backlight of the liquid crystal display television can. In order to realize the local adjustment of the backlight, the laser projection device may be realized in the following ways.

In a possible implementation, referring to FIG. 2, the addition of an additional light modulator makes output of the light source first modulated by a first light modulator and then irradiated to a second light modulator for modulation and display. This solution has poor practicability, fails to increase peak brightness, and exhibits low light efficiency. After the first light modulator performs modulation, dark-field light is discarded, and only bright-field light is reflected to the second light modulator for display. Referring to FIG. 2, by significantly reducing the dark-field brightness, the local adjustment of the backlight is achieved, thereby realizing HDR display effect.

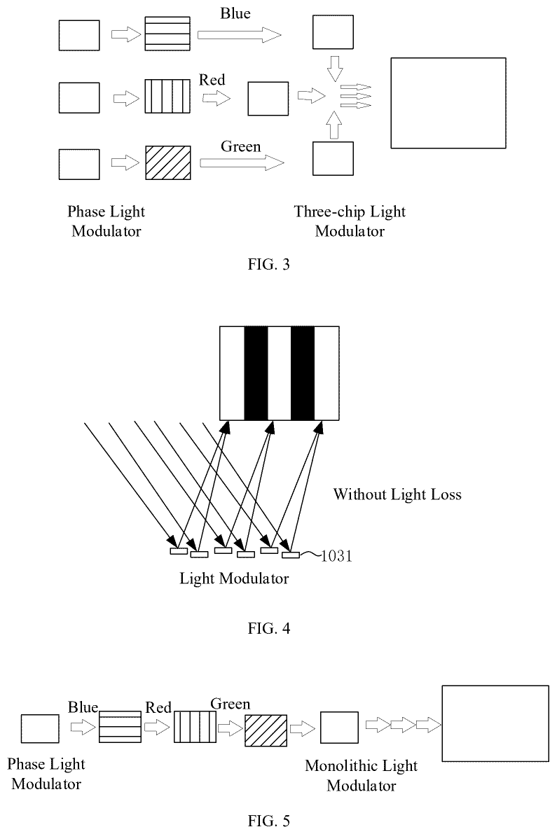

In another possible implementation, referring to FIG. 3, for a display technology of a three-chip three-color laser light modulator, a primary light from each channel to the light modulator is modulated by the addition of a phase light modulator. Phase modulation of the phase light modulator is shown in FIG. 4. An advantage of the phase light modulation is that it may not only reduce the dark-field brightness, but also increase the peak brightness, thereby achieving a large range of local adjustment of the backlight and high light efficiency. The technology of the phase light modulation has an extremely high technical advantage. Since three primary colors may be combined in space through a light device (such as a three-chip light modulator in FIG. 3) for final display, a display timing and a phase light modulation timing may only meet frame synchronization of a video image, without considering additional signal synchronization requirements. Referring to FIG. 3, a square including vertical profile lines represents a red image, a square including oblique profile lines represents a green image, and a square including transverse profile lines represents a blue image. A blank square on the rightmost side represents a composite image of the red image, the green image, and the blue image.

In another possible implementation, as for a display technology of a monolithic light modulator (referring to FIG. 5), a laser projection device is provided by an embodiment of the present disclosure. The laser projection device uses the phase light modulator to adjust phase of the output of the light source and realize spatial distribution adjustment of light energy. Combined with a primary color display timing sequence of the monolithic light modulator, synchronization between local adjustment of backlight of each primary color and a timing sequence of the display is realized, with the peak brightness improved and the dark-field brightness reduced, thereby improving light energy efficiency and realizing HDR display. A lighting timing sequence of the primary color lights displayed by the monolithic light modulator is time-division multiplexed. Referring to FIG. 5, a square including vertical profile lines represents a red image, a square including oblique profile lines represents a green image, and a square including transverse profile lines represents a blue image. A blank square on the rightmost side represents a composite image of the red image, the green image, and the blue image.

Relevant basic principles of local adjustment of the backlight of the phase light modulator are introduced below.

The phase light modulator is a device that includes multiple micron-sized modulating light micro-mirrors 1031. A reflection surface of each of one or more micro-mirrors is a plane and may be moved up and down in a direction perpendicular to the reflection surface. A phase relationship between light incident on each of one or more micro-mirrors 1031 is changed by up and down displacement of each of one or more micro-mirrors 1031, referring to FIG. 4. Because the laser is coherent light, when phase changes, diffraction is formed, in order to achieve adjustment of the light intensity distribution of an image. In actual display effect, light in a dark area of the image may be “moved” to a bright area, making the bright area brighter and the dark area darker, in order to realize HDR local adjustment of the backlight.

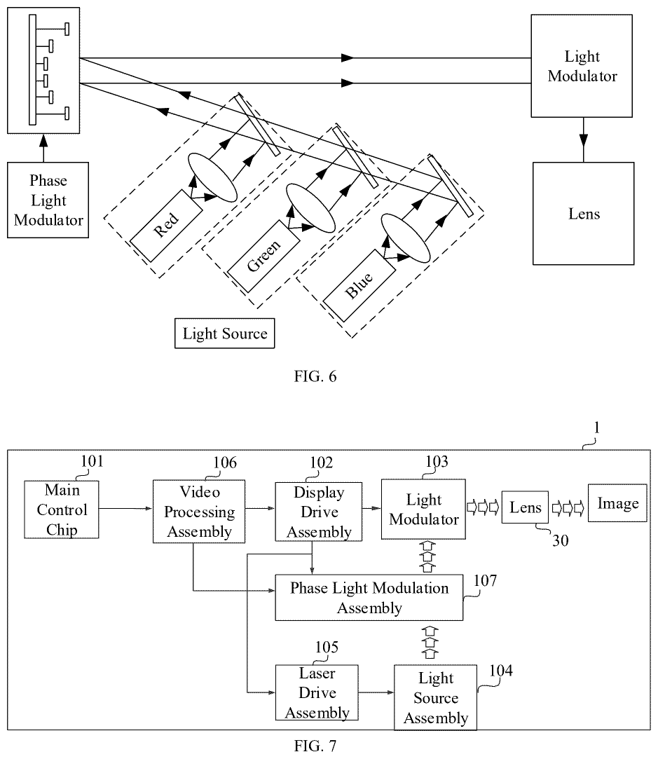

A monolithic phase light modulator is matched with the light modulator to achieve the local adjustment of the backlight. Referring to FIG. 6, light sources of three-color laser light up and emit light in a timing sequence. When a monochromatic laser is irradiated onto the phase light modulator, because the device may modulate phase of light based on content of the displayed image, the phase is changed by the up and down displacement of the pixel point (i.e., the micro-mirror 1031), then a modulated light is input to a surface of the light modulator, making diffraction light in a bright area of a corresponding image be strong, and diffraction light in a dark area of a corresponding image be weak, in order to realize the local adjustment of the backlight. The diffraction light is further modulated by the light modulator through Pulse Width Modulation (PWM), and then imaged on a screen through the lens to achieve HDR display.

That is to say, light intensity of at least two beams in an illumination beam after being dimmed by the phase light modulator is different. In this way, brightness difference between at least two image partitions in a projected image may be enlarged, such that dynamic contrast of the projected image may be improved without changing brightness of the light source and without processing the projected image, thereby improving display effect of subsequent images projected through the lens.

Specifically, phase information in a spatial light field is required to control the phase light modulator. Since the phase information may not be measured, a phase recovery algorithm is needed to obtain the phase information. Using amplitude (intensity) information of the light field of a known input plane (image plane) and an output plane (far-field diffraction plane, i.e. the light modulator), that is, a transformation relationship between the two light fields is known. The phase information of the light field may be solved iteratively by diffraction calculation (multiple times of constraint, substitutions and transformations are performed in both spatial and spectral domains). Here, it takes Gerchberg-Saxtong (hereinafter referred to as GS) algorithm as an example. Input surface light-wave function f(x,y) of the illumination beam output by the light source at the phase light modulator may be expressed as:

$$f ( x , y ) = A ( x , y ) exp ( i Φ ( x , y ) ) \qquad ( 1 )$$

A(x,y) and Φ(x,y) represent amplitude distribution of the light field and phase distribution at the phase light modulator. A(x,y) is a known quantity. Φ(x,y) may be estimated at an initial operation. (x,y) represents a point coordinate of the input plane (image plane).

After phase modulation is performed, amplitude distribution and phase distribution at the output plane may be expressed by light-wave function g(u,v):

$$g ( u , v ) = B ( u , v ) exp ( i θ ( u , v ) ) \qquad ( 2 )$$

B(u,v), θ(u,v), and (u,v) respectively represent amplitude distribution, phase distribution, and a point coordinate on the output plane of the illumination beam after the phase modulation is performed. Since modulated light intensity information depends on a video signal, the amplitude distribution is known.

Based on the light-wave functions f and g, the following transformation conditions are satisfied:

$$g = F ( f ) , f = F - 1 ( g ) \qquad ( 3 )$$

F represents Fourier transform, and F-1 represents inverse Fourier transform. Therefore, an output light-wave function may be obtained by the Fourier transform from an input light-wave function, and the input light-wave function may be obtained by the inverse Fourier transform from the output light-wave function.

In summary, a process of the GS algorithm is as follows.
Step 1: initial input phase information Φ0(x,y) is estimated, and n is the number of cycles.
Step 2: the Fourier transform is performed on the input function f(x,y)=A(x,y)exp(iΦ0(x,y)) to obtain the light-wave function g′(u,v), g′(u,v)=B′(u,v)exp(iθn(u, v)) in the input function, and a phase relationship θn(u,v) is obtained.
Step 3: the phase information in the output function is replaced with θn(u,v) to obtain g(u,v)=B(u,v)exp(iθn(u,v)).
Step 4: the inverse Fourier transform of g(u,v)=B(u,v) exp(iθn(u,v)) is performed to obtain f′(x,y)=A′(x,y)exp(iΦn(x,y)).
Step 5: whether a mean square error between the output amplitude B′(u,v) and B(u,v) is less than specified index ε or reaches a certain number of iterations K is determined. If it is not, then step 6 is performed, and if it is yes, step 7 is performed.
Step 6: the phase information in the input function is replaced with Φn(x,y), and repeat step 2.
Step 7: a phase retrieval operation is completed, and Φk(x,y) is a phase distribution function representing the phase information required by the phase light modulator.

The following is a detailed description of the technical scheme of the present disclosure, combined with specific embodiments. The following specific embodiments may be combined with each other, and the same or similar concepts or processes may not be repeated in some embodiments.

FIG. 7 is a schematic structural diagram of a laser projection device provided according to an embodiment of the present disclosure. Referring to FIG. 7, the laser projection device 1 may include a main control chip 101, a display drive assembly 102, a light modulator 103, a light source assembly 104, and a laser drive assembly 105.

The main control chip 101 is configured to generate a video signal based on an external video source. For example, the external video source may be a network video source, a High Definition Multimedia Interface (HDMI) video signal or a video source in a storage medium such as a USB flash disk. The video signal that is decoded may be a digital interface standard (V-By-One) signal developed for image transmission, or a Low Voltage Differential Signaling (LVDS) of a technical interface, and so on.

The display drive assembly 102 is connected to the laser drive assembly 105 and the light modulator 103, respectively. The display drive assembly 102 is configured to obtain the video signal, send an enable signal and a Pulse Width Modulation (PWM) signal to the laser drive assembly 105 based on the video signal, and send a display drive signal to the light modulator 103 based on the video signal. The display drive signal is transmitted based on a first timing sequence. For example, if the first timing sequence is an R-G-B cycle (i.e., red-green-blue cycle, and the following uses R to represent red light, G to represent green light, and B to represent blue light), the light modulator 103 displays images in an order of red light-green light-blue light.

In a possible embodiment, synchronous signals sent by the display drive assembly 102 to the laser driver assembly 105 may include an enable signal and a PWM signal. The enable signal may be a timing control signal. The enable signal may usually be expressed as X_EN. X represents abbreviations of different primary colors. The enable signal is configured to coordinate a timing sequence of different color light outputs. The PWM signal is a square wave signal and is configured to provide a current signal for laser lighting. The display drive assembly 102 is able to determine the enable signal and the PWM signal based on the video signal.

In a possible embodiment, after receiving the video signal, the display drive assembly 102 determines display image quality requirement based on the video signal, and then determines a first timing sequence based on the display image quality requirement. Besides, a display drive signal is generated based on a specific partition condition of the light modulator 103 and a bit range of each primary color pixel.

The laser drive assembly 105 is connected to the light source assembly 104. The laser drive assembly 105 is configured to send a light source drive signal to the light source assembly 104 based on the synchronous signal, in order to drive the light source assembly 104 to light up and emit one of the multiple primary color lights. The light source drive signal is transmitted based on a second timing sequence.

For example, the light source assembly 104 may include a three-color laser. That is, a laser has three colors: red, green, and blue. If the second timing sequence is the R-G-B cycle, the light source assembly 104 emits a three-color laser beam in a sequence of red light, green light, and blue light through the three-color laser.

In a possible embodiment, referring to FIG. 7, the laser projection device may further include a video processing assembly and a phase light modulation assembly.

The video processing assembly 106 is connected to the main control chip 101 and the phase light modulation assembly 102, respectively. The video processing assembly 106 is configured to receive the video signal sent by the main control chip 101, and send a phase video signal to the phase light modulation assembly 107 based on the video signal.

Specifically, the video processing assembly 106 may perform a phase recovery operation on the video signal to generate the phase video signal, such that the phase modulation may be performed by the phase light modulation assembly 107 based on the phase video signal.

The display drive assembly 102 is connected to the phase light modulation assembly 107. The display drive assembly 102 is further configured to send the enable signal to the phase light modulation assembly 107. A synchronous signal transmitted by the display drive assembly 102 to the phase light modulation assembly 107 may include only the enable signal, or the synchronous signal transmitted by the display drive assembly 102 to the phase light modulation assembly 107 may also include the enable signal and the PWM signal.

The phase light modulation assembly 107 is configured to modulate phase light based on the phase video signal and the synchronous signal (such as the enable signal) to transmit the modulated light to the light modulator 103. The phase video signal and the synchronization signal may be transmitted based on a third timing sequence. For example, if the third timing sequence is the R-G-B cycle, the phase light modulation assembly 107 performs phase light modulation in the order of red light-green light-blue light.

The light modulator 103 is configured to display an image based on the modulated light.

In a possible embodiment, the light modulator 103 is configured to refresh a state of each of the one or more micro-mirrors 1031 on the light modulator 103 based on the first timing sequence. The state is on or off. Through the one or more micro-mirrors 1031 of the light modulator 103, after the state is refreshed, image display is realized based on the modulated light received.

The first timing sequence, the second timing sequence, and the third timing sequence are synchronized, and duration of each primary color is equal, such that the light source of the light source assembly 104 lights up, the light modulator 103 realizes image display, and the phase light modulation assembly 107 performs phase light modulation are synchronized.

In order to realize synchronization of the first timing sequence and the third timing sequence, because on-off of the laser has a certain lag, the display drive assembly 102 may fine-tune a delay of the first timing sequence, in order to make the first timing and the third timing synchronized.

In a possible embodiment, the main control chip 101 is a System On Chip (SOC). In a possible embodiment, the display drive assembly 102 is a Digital Light Processing (DLP) chip. In a possible embodiment, the light modulator 103 is a Digital Micromirror Device (DMD).

In a possible embodiment, the video processing assembly 106 may include a Field Programmable Gate Array (FPGA) chip, or the video processing assembly 106 is a Graphics Processing Unit (GPU) that may be configured with storage. For example, Double Data Rate Synchronous Dynamic Random Access Memory (DDR SDRAM). Thereby, cooperate with the FPGA chip or the GPU to achieve large-scale image processing operations.

In some embodiments of the present disclosure, the display drive assembly 102 is configured to obtain the video signal, send the synchronization signal to the laser drive assembly 105 based on the video signal, and send the display drive signal to the light modulator 103 based on the video signal. The laser driving assembly 105 is configured to send the light source drive signal to the light source assembly 104 based on the synchronous signal, in order to drive the light source assembly 104 to light up and emit the one of the multiple primary color lights. The video processing assembly 106 is configured to send the phase video signal to the phase light modulation assembly 107 based on the video signal. The display drive assembly 102 is further configured to send the synchronous signal to the phase light modulation assembly 107. The phase light modulation assembly 107 is configured to perform the phase light modulation based on the phase video signal and the synchronization signal, in order to transmit the modulated light to the light modulator 103. The light modulator 103 is configured to realize redistribution of light energy in space when the local backlight adjustment is realized based on the image displayed by the modulated light in the first timing sequence, in order to improve brightness of the peak and reduce brightness of the dark-field, and improve the light energy efficiency.

In embodiments of the present disclosure, the video signal may be obtained by display drive assembly 102 in the following two ways.

In some embodiments, referring to FIG. 7, the video processing assembly 106 is connected to the display drive assembly 102, and the display drive assembly 102 is specifically configured to: receive the video signal sent by the video processing assembly 106.

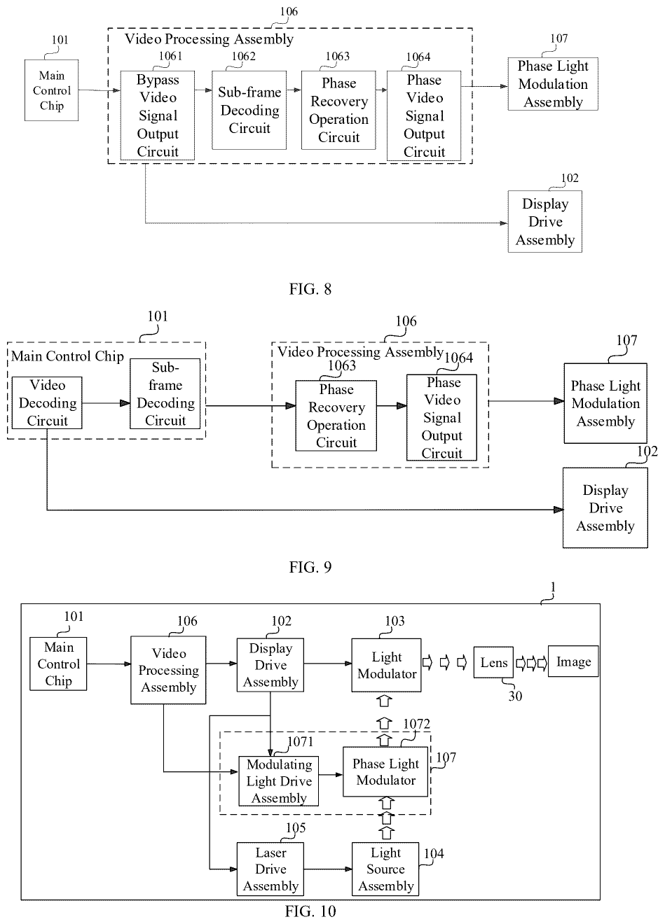

In another possible embodiment, referring to FIG. 9, the main control chip 101 is connected to the display drive assembly 102, and the display drive assembly 102 is specifically configured to: receive the video signal sent by the main control chip 101.

In the following, the phase video signal generated by the video processing assembly 106 based on the video signal is described in detail.

The video signal is usually a multi-channel serial signal. The video signal first needs to be decoded to generate multiple sub-video signals. For example, the multiple sub-video signals may include: an R sub-video signal, a G sub-video signal, and a B sub-video signal.

In the embodiments of the present disclosure, there may be following two ways to generate the multiple sub-video signals.

Decoding method 1: the video processing assembly 106 generates the multiple sub-video signals based on the video signal, making an interface link simpler but increasing computing power of the video processing assembly 106. After the video signal is output from a video interface of the main control chip 101 and input to the video processing assembly 106, the video signal may be decoded, by the video processing assembly 106, to obtain the R sub-video signal, the G sub-video signal, and the B sub-video signal, and the sub-video signal may be stored in the storage.

Decoding method 2: the main control chip 101 generates multiple sub-video signals based on the video signal, and then inputs the multiple sub-video signals to the video processing assembly 106. This way may reduce computing power requirements of the video processing assembly 106, and convert this part of the processing process to the main control chip 101.

The video processing assembly 106 is specifically configured to obtain the multiple sub-video signals, and the multiple sub-video signals are obtained after the video signal is decoded. For any one of the sub-video signals, phase information signal corresponding to the sub-video signal is determined. The phase video signal is determined based on the phase information signals of the multiple sub-video signals. Understandably, the phase information signal may include multiple phase image information.

For the above decoding method 1 which generates the multiple sub-video signals, referring to FIG. 8, the video processing assembly 106 may include a bypass video signal output circuit 1061, a sub-frame decoding circuit 1062, a phase recovery operation circuit 1063, and a phase video signal output circuit 1064.

Referring to FIG. 8, the bypass video signal output circuit 1061 is configured to split the video signal into two paths within the video processing assembly 106. One path is configured to decode the sub-video signal. The other path, without image processing, directly outputs the video signal to the display drive assembly 102 for image display by the light modulator 103.

The sub-frame decoding circuit 1062 is configured to receive the video signal from the main control chip 101, and based on the video signal, obtain a horizontal synchronization signal, a field synchronization signal, an enable synchronization signal, and R grayscale value information, G grayscale value information, and B grayscale value information of all pixels. The R sub-video signal is generated based on the R grayscale value information, the G sub-video signal is generated based on the G grayscale value information, and the B sub-video signal is generated based on the B grayscale value information. The R sub-video signal, the G sub-video signal, and the B sub-video signal may be stored in the storage for subsequent phase recovery operations.

Specifically, relationships between the video signal, the sub-video signal, and the image are as follows: the video signal may include multiple images. For any image corresponding to the video signal, the image may include an R sub-image, a G sub-image, and a B sub-image. The R sub-video signal is generated by multiple R sub-images, the G sub-video signal is generated by multiple G sub-images, and the B sub-video signal is generated by multiple B sub-images.

In a possible embodiment, the sub-frame decoding circuit 1062 determines whether to compress resolution of an image based on resolution of the phase light modulation assembly 107 in the phase light modulation assembly 107. Specifically, first resolution of the phase light modulation assembly 107 is obtained. Based on the first resolution, pixel compression is performed on an image with a resolution higher than the first resolution from the video signal, such that the resolution of a compressed image matches the first resolution.

Specifically, for the image with resolution higher than the first resolution from the video signal, the sub-frame decoding circuit 1062 performs pixel compression on the image based on the first resolution, such that resolution of a pixel-compressed image matches the first resolution.

In other words, when the number of pixels of the phase light modulation assembly 107 (the phase light modulator 1072) is smaller than the number of pixels of the light modulator 103, a high-resolution image from the video signal needs to be compressed to obtain a low-resolution image, such that the low-resolution image matches a required number of pixels in the phase light modulation assembly 107. A subsequent phase recovery operation is then performed based on a resolution-adjusted image to obtain the phase video information, further reducing time required for the subsequent phase recovery operation.

The phase recovery operation circuit 1063 is configured to read the R sub-video signal, G sub-video signal, and the B sub-video signals from the storage. Using the R sub-video signal as an example, multiple iterative operations are performed by using the phase recovery algorithm to obtain phase information for each pixel from the R sub-video signal and generate R phase image information. The phase image information generated may be cached in the storage for subsequent output. Phase recovery operation time for the R sub-video signal, the G sub-video signal, and the B sub-video signal may be less than display duration of each frame.

The phase video signal output circuit 1064 is configured to generate the phase video signal based on the horizontal synchronization signal that is decoded, the field synchronization signal that is decoded, the enable synchronization signal that is decoded, and a combination of the R phase image information, G phase image information, and B phase image information.

It should be noted that in order to ensure that the video signal and phase video signal output by the video processing assembly 106 are synchronized, the bypass video signal output circuit 1061 may adjust a delay of the video signal output to the display drive assembly 102, such that the video signal and the phase video signal are output synchronously.

For the aforementioned decoding method 2 that generates multiple sub-video signals, referring to FIG. 9, the main control chip 101 may include a sub-frame decoding circuit. That is, the main control chip 101 needs to add a sub-video signal decoding function on the basis of normal video signal decoding, and further add an additional video signal output port for outputting the sub-video signals. Output of the video signal requires a delay to be adjusted to meet computational time requirements. The sub-video signal needs to maintain a stable phase difference and frame synchronization with the video signal, ensuring that the video signal and the phase video signal are output synchronously.

Specifically, the main control chip 101 decodes an external video source to obtain the video signal while simultaneously generating the sub-video signal. The main control chip 101 may also compress the image corresponding to the video signal based on resolution of the phase light modulation assembly 107 of a back end to generate the sub-video signal. The sub-video signal may be output via a Transistor-Transistor Logic (TTL) interface to simplify decoding requirements of the video processing assembly 106.

Correspondingly, referring to FIG. 9, the video processing assembly 106 may include the phase recovery operation circuit 1063 and the phase video signal output circuit 1064. Since the video signal does not need to be decoded by the video processing assembly 106 to obtain the sub-video signal, the video processing assembly 106 only needs to receive the sub-video signal.

The phase recovery operation circuit 1063 is configured to receive the R sub-video signal, the G sub-video signal, and the B sub-video signal. Using the R sub-video signal as an example, multiple iterative operations are performed by using a phase recovery algorithm to obtain the phase information for each pixel from the R sub-video signal and generate the R phase image information. The phase image information generated may be cached in the storage for subsequent output. Phase recovery operation time for the R sub-video signal, the G sub-video signal, and the B sub-video signal may be less than display duration of each frame.

The phase video signal output circuit 1064 is configured to generate the phase video signal based on the horizontal synchronization signal, the field synchronization signal, and the enable synchronization signal decoded by the main control chip 101 obtained, and the combination of the R phase image information, the G phase image information, and the B phase image information.

In a possible implementation, in the decoding method 2, the video signal and the sub-video signal are received respectively by the video processing assembly 106, and delay adjustment and output of the video signal are performed by the video processing assembly 106. This method has an advantage of using a unified chip (a chip in the video processing assembly 106) to adjust a timing sequence.

Below, the phase light modulation is implemented by the phase light modulation assembly 107 is described in detail.

Referring to FIG. 10, FIG. 10 is a schematic structural diagram of another laser projection device provided according to the present disclosure. The laser projection device 1 may include: the main control chip 101, the display drive assembly 102, the light modulator 103, the light source assembly 104, the laser drive assembly 105, and the video processing assembly 106.

For connection relationships among the main control chip 101, the display drive assembly 102, the light modulator 103, the light source assembly 104, the laser drive assembly 105, and the video processing assembly 106, as well as the specific implementation, references are made to the above embodiments and are not repeated here.

The phase light modulation assembly 107 may include a modulating light drive assembly 1071 and the phase light modulator 1072.

The modulating light drive assembly 1071 is electrically connected to the video processing assembly 106, the display drive assembly 102, and the phase light modulator 1072, respectively. The video processing assembly 106 is configured to send the phase video signal to the modulating light drive assembly 1071. The display drive assembly 102 is configured to send the enable signal to the modulating light drive assembly 1071. The modulating light drive assembly 1071 is configured to determine a bias voltage of the phase light modulator 1072 based on the enable signal. The phase video signal and the bias voltage are then sent to the phase light modulator 1072.

The phase light modulator 1072 is configured to perform the phase light modulation based on the phase video signal and the bias voltage, thereby transmitting the modulated light to the light modulator 103, such that the light modulator 103 displays the image based on the modulated light. In a possible implementation, the phase light modulator 1072 is a Phase Light Modulator (PLM).

It's known that when light waves travel a consistent geometric distance in a medium, phase change is related to a wavelength of the light wave. For the modulating light drive assembly 1071, input to the modulating light drive assembly 1071 is the phase video signal, namely, multiple phase image information (images after the Fourier transformation). Therefore, the maximum adjustable displacement of the lens is particularly important, and the bias voltage determines the maximum displacement of the one or more micro-mirrors 1031 in a PLM chip. Therefore, different bias voltages correspond to three light waves of different wavelengths. In other words, it is a wavelength of light that influences the phase modulation. For different light waves with different wavelengths, the phase modulation of the light wave may be achieved by shifting the lens with different bias voltages.

The bias voltage may determine step lengths of displacement of the one or more micro-mirrors 1031 of the PLM chip (phase light modulator 1072). Since the number of the step lengths of displacement of the one or more micro-mirrors 1031 of the PLM chip are fixed, it may also be considered that the bias voltage determines the maximum displacement value of the one or more micro-mirrors 1031 of the PLM chip.

In a possible implementation, the phase light modulator 1072 is specifically configured to: control displacement of the one or more micro-mirrors 1031 of the phase light modulator 1072 based on the bias voltage, in order to perform the phase modulation on the primary light through the one or more micro-mirrors 1031 after the displacement to achieve precise phase adjustment of light of different wavelengths. The bias voltage may include sub-bias voltages corresponding to primary lights of different wavelengths. For example, the bias voltage may include a sub-bias voltage corresponding to a red primary light, a sub-bias voltage corresponding to a green primary light, and a sub-bias voltage corresponding to a blue primary light. Alternatively, it may be understood that each of the multiple primary color lights corresponds to a different target voltage.

In a possible implementation, the phase light modulator 1072 is specifically configured to: adjust the step lengths of displacement of the one or more micro-mirrors 1031 on the phase light modulator 1072 based on the bias voltage. The phase modulation is performed on the primary light to achieve precise phase adjustment of lights of different wavelengths by one or more adjusted micro-mirrors 1031.

In a possible implementation, the phase light modulator 1072 is specifically configured to: adjust the maximum displacement of the one or more micro-mirrors 1031 of the phase light modulator 1072 based on the bias voltage. The phase modulation is performed on the primary light to achieve precise phase adjustment of lights of different wavelengths by one or more adjusted micro-mirrors 1031.

It may be understood that since the second timing sequence and the third timing sequence are synchronized, for example, taking the red primary light as an example, when the light source assembly 104 emits the red primary light, the phase light modulation assembly 107 controls up and down displacement of the one or more micro-mirrors 1031 based on the sub-bias voltage corresponding to the red light, such that the one or more micro-mirrors 1031 after the displacement may perform the phase modulation on the red primary light emitted by the light source assembly 104.

In a possible implementation, a timing when the phase light modulation assembly 107 receives a modulating light drive signal is consistent with a timing when the light modulator 103 receives the display drive signal. “Consistency” here means that the phase light modulation assembly 107 receives the modulating light instruction synchronously with the light modulator 103 receiving the display instruction. Specifically, for example, a delay of a faster-transmitting drive signal may be adjusted to meet a transmission time requirement of a slower-transmitting drive signal, such that the phase light modulator 1072 and the light modulator 103 receive the drive signals simultaneously.

In a possible implementation, display duration of a video signal corresponding to a target primary color of a target frame displayed by the light modulator 103 overlaps, at least in part, with display duration of a phase video signal corresponding to the target primary color of the target frame displayed by the phase light modulator 1072. The target frame is any frame.

In a possible implementation, the display drive assembly 102 may incorporate image correction functions such as projection keystone correction, screen entry correction, or obstacle avoidance. The addition of the image correction functions requires additional image correction processing operations. For example, after buffering one frame of image information, an image correction algorithm may be used to shift corresponding pixels and recalculate the corresponding pixels'grayscale information to implement the image correction functions. Therefore, it is necessary to increase a delay in the modulating light drive assembly 1071 sending the modulating light drive signal to the phase light modulator 1072, in order to synchronize the display drive signals output by the display drive assembly 102.

In a possible implementation, the light modulator 103 is specifically configured to: refresh states of multiple micro-mirrors 1031 of the light modulator 103 based on the first timing sequence, with the state being on or off, and receive the modulated light through refreshed multiple micro-mirrors 1031 of the light modulator to display the image.

For example, taking the red primary light as an example, when the light source assembly 104 emits the red primary light, the phase light modulator 1072 controls the up and down displacement of the one or more micro-mirrors 1031 based on the bias voltage corresponding to the red light, such that one or more displaced micro-mirrors 1031 may perform the phase modulation on the red primary light emitted by the light source assembly 104. The light modulator determines to refresh the one or more micro-mirrors 1031 corresponding to the red primary light of the light modulator 103, causing the phase light modulator 1072 to send the modulated light to the light modulator 103. The light modulator 103 receives the modulated light corresponding to the red primary light through the refreshed the one or more micro-mirrors 1031 to display the image.

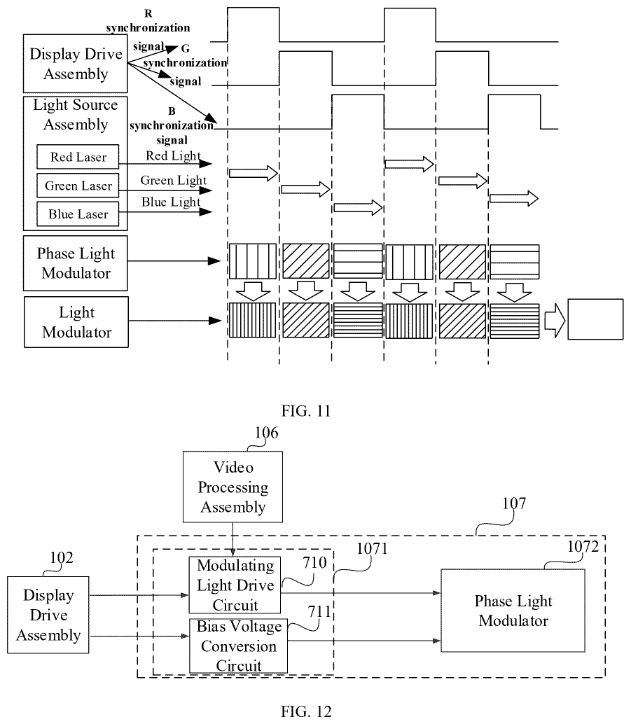

Specifically, referring to FIG. 11, FIG. 11 is a schematic diagram of synchronization among a light source, phase modulation, and display. That is, synchronization is among the light source assembly 104 emitting red primary light, the phase light modulator 1072 performing the phase modulation on the red primary light, and the light modulator 103 performing image display by means of the modulated light corresponding to the red primary light. The following takes red primary light as an example for illustration.

Before the laser drive assembly 105 and the modulating light drive assembly 1071 receive the synchronization signal, the light modulator 103 and the phase light modulator 1072 may first complete reception of red image data.

When the laser drive assembly 105 and the modulating light drive assembly 1071 receive the synchronization signal, the following operations may be performed synchronously.
(1) The laser drive assembly 105 drives a red laser to light up from the light source assembly 104, in order to emit a red primary color light to the phase light modulator 1072, and the lasers of other colors are turned off.
(2) The phase light modulator 1072 receives the modulating light drive signal sent by the modulating light drive assembly 1071, in order to send a sub-bias voltage corresponding to the red primary color light to the phase light modulator 1072 (the minimum unit of the micro-mirror displacement of the phase light modulator 1072 meets a requirement of a red laser wavelength). After receiving the modulating light drive signal, the phase light modulator 1072 moves the one or more micro-mirrors 1031 up and down based on the sub-bias voltage to achieve phase modulation of the red primary color light. That is, backlight adjustment for low resolution is achieved.
(3) The light modulator 103 receives the display drive signal sent by the display drive assembly 102. After receiving the display drive signal, the light modulator 103 refreshes the states of the one or more micro-mirrors 1031 of the light modulator 103. By adjusting flipping timing of the micro-mirrors 1031, multiple micro-mirrors 1031 are flipped simultaneously based on the states that are determined to perform PWM modulation of the modulated light transmitted by the phase light modulator 1072. That is, high display resolution is achieved, thereby realizing image display.

It should be noted that, referring to FIG. 11, a square including vertical cross-section lines represents a red image, and the denser the cross-section lines are, the higher the resolution is. A square including oblique cross-section lines represents a green image, and the denser the cross-section lines are, the higher the resolution is. A square including horizontal cross-section lines represents a blue image, and the denser the cross-section lines are, the higher the resolution is. A blank square represents an image composed of the red image, the green image, and the blue image. In addition, synchronization corresponding to other primary colors is consistent with the red primary color light. For the green primary color light and the blue primary color light, the above-mentioned red primary color light may be referred to. No further elaboration is needed here.

In this embodiment, the display drive assembly 102 is configured to acquire the video signal, send the synchronization signal to the laser drive assembly 105 and the modulating light drive assembly 1071 based on the video signal. Furthermore, the display drive signal is sent to the light modulator 103 based on the video signal. The laser drive assembly 105 is configured to send the light source drive signal to the light source assembly based on the synchronization signal, thereby driving the light source assembly 104 to light up and emit one of the multiple primary color lights. The video processing assembly 106 is configured to send the phase video signal to the modulating light drive assembly 1071 based on the video signal. The modulating light drive assembly 1071 is configured to send the modulating light drive signal to the phase light modulator 1072 based on the phase video signal and the synchronization signal, causing the phase light modulator 1072 to perform the phase light modulation based on the modulating light drive signal, thereby transmitting the modulated light to the light modulator 103. The light modulator 103 is configured to display images based on the modulated light, enabling spatial redistribution of light energy when achieving local backlight modulation, increasing peak brightness and reducing dark-field brightness, and thereby improving light energy efficiency.

The following describes in detail how the phase light modulation assembly 107 performs the phase modulation on each primary light color. FIG. 12 is a schematic structural diagram of the phase light modulation assembly 107 provided according to an embodiment of the present disclosure. Referring to FIG. 12, the phase light modulation assembly 107 may include the modulating light drive assembly 1071 and the phase light modulator 1072. The modulating light drive assembly 1071 may include a modulating light drive circuit 710 and a bias voltage conversion circuit 711.

The video processing assembly 106 is connected to the modulating light drive circuit 710. The video processing assembly 106 is specifically configured to send the phase video signal to the modulating light drive circuit 710 based on the video signal.

The display drive assembly 102 is respectively connected to the modulating light drive circuit 710, the bias voltage conversion circuit 711, and the laser drive assembly 105. The display drive assembly 102 is specifically configured to send the enable signal to the modulating light drive circuit 710 and the bias voltage conversion circuit 711.

In a possible implementation, the display drive assembly 102 may include a Digital-to-Analog Converter (DAC). The display drive assembly 102 is specifically configured to determine the PWM signal based on the video signal, perform digital-to-analog conversion on the PWM signal by the DAC, and obtain an analog signal corresponding to the PWM signal. The analog signal and the enable signal are then sent to the laser drive assembly 105.

Accordingly, the laser drive assembly 105 may generate the light source drive signal based on the analog signal and the enable signal.

The bias voltage conversion circuit 711 is connected to the phase light modulator 1072. The bias voltage conversion circuit 711 is configured to send the bias voltage to the phase light modulator 1072 based on the enable signal.

The modulating light drive circuit 710 is connected to the phase light modulator 1072. The modulating light drive circuit 710 is configured to send the phase image information to the phase light modulator 1072 from the phase video signal based on the enable signal, drive the one or more micro-mirrors 1031 of the phase light modulator 1072 to move under the action of the bias voltage, and combine the phase video signal to achieve the phase modulation.

It may be understood that the phase video signal is composed of continuous phase image information (the continuous phase image information may also be called a hologram). Therefore, the modulating light drive circuit 710 may enable the phase light modulator 1072 to achieve the phase modulation based on the corresponding phase image information and the bias voltage, according to a cyclic order of the primary color lights of the third timing sequence.

The following is an exemplary description of the embodiments of the bias voltage conversion circuit 711 provided based on the embodiments of the present disclosure. It should be noted that the bias voltage conversion circuit 711 provided in the embodiments of the present disclosure may be applied to any laser projection device that needs to generate the bias voltage, and is not limited to being applied to the laser projection device 1 shown in FIG. 7 and FIG. 10. Furthermore, the bias voltage conversion circuit 711 provided in the embodiments of the present disclosure may be applied to any laser projection device that needs to generate multiple bias voltages.

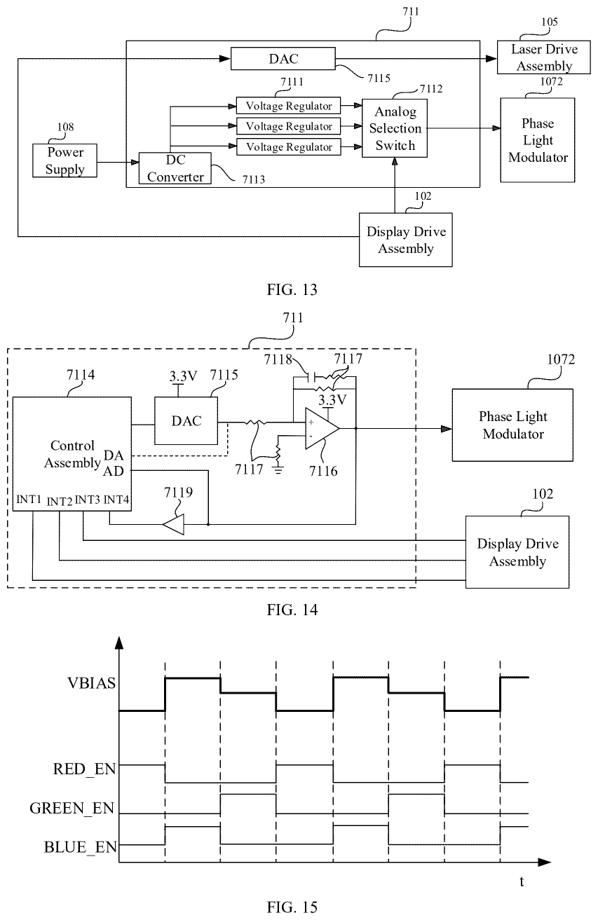

In a possible implementation, FIG. 13 is a schematic structural diagram of the bias voltage conversion circuit 711 provided according to an embodiment of the present disclosure. Referring to FIG. 13, the bias voltage conversion circuit 711 may include multiple voltage regulators 7111 and an analog selection switch 7112. The analog selection switch 7112 is respectively connected to the multiple voltage regulators 7111 and the phase light modulator 1072. The multiple voltage regulators 7111 are configured to send multiple target voltages to the analog selection switch 7112. The analog selection switch 7112 is configured to determine the bias voltage from the multiple target voltages and send the bias voltage to the phase light modulator 1072. Thus, the bias voltage conversion circuit 711 provided in the embodiments of the present disclosure is capable of generating multiple bias voltages.

When the bias voltage conversion circuit 711 is applied to the laser projection device shown in FIG. 7 and FIG. 10, referring to FIG. 13, the analog selection switch 7112 is also connected to the display drive assembly 102. The multiple voltage regulators 7111 are configured to send the target voltages corresponding to multiple primary colors to the analog selection switch 7112. For example, three voltage regulators 7111 are taken as an example in the figure. The three voltage regulators 7111 send the target voltages corresponding to the red primary color, the green primary color, and the blue primary color to the analog selection switch 7112, respectively.

The display drive assembly 102 is configured to send the enable signal to the analog selection switch 7112.

The analog selection switch 7112 is configured to determine the bias voltage from target voltages corresponding to multiple primary color lights based on the enable signal, and send the bias voltage to the phase light modulator 1072.

Exemplarily, if the third timing sequence determined by the enable signal is the R-G-B cycle, for example, when cycling to R, the analog selection switch may determine a target voltage corresponding to the red primary light from among the target voltages corresponding to the red primary light, the green primary light, and the blue primary light as the bias voltage. The target voltages corresponding to the three primary lights are input to the analog selection switch 7112 via three voltage regulators 7111, respectively, enabling the analog selection switch 7112 to output different bias voltages based on the third timing sequence, and achieving a purpose of voltage switching. In other words, while light of a specific color is projected onto the phase light modulator 1072, the bias voltage is also switched to a corresponding voltage value, in order to determine movement of the one or more micro-mirrors 1031 of the phase light modulator 1072 to achieve the phase modulation.

In a possible embodiment, the laser projection device 1 may further include a power supply 108. The bias voltage conversion circuit 711 may further include a Direct Current (DC/DC) converter 7113. The DC converter 7113 is connected to the power supply 108 and the multiple voltage regulators 7111, respectively. The DC converter 7113 is configured to input a first voltage to each of the multiple voltage regulators 7111 based on a drive voltage input from the power supply 108. For any voltage regulators 7111, the DC converter 7113 is configured to input a target voltage corresponding to the voltage regulator 7111 to the analog selection switch 7112 based on the first voltage. Each of the multiple voltage regulators 7111 corresponds to a different target voltage.

For example, the power supply 108 may generate a 12V supply voltage to drive the bias voltage conversion circuit 711 to work. After a voltage signal of 12V passes through the DC/DC converter, a 5V voltage signal is generated. The 5V voltage signal is input into the three voltage regulators 7111, respectively. By varying resistance values of resistors of the voltage dividers in the three voltage regulators 7111, different target signals may be generated, enabling the analog selection switch 7112 to perform voltage switching to output a corresponding bias voltage.

In a possible implementation, referring to FIG. 13, the DAC 7115 may be added to the bias voltage conversion circuit 711. The display drive assembly 102 is specifically configured to: determine the PWM signal based on the video signal, and perform digital-to-analog conversion of the PWM signal by using the DAC 7115 of the bias voltage conversion circuit 711 to obtain an analog signal corresponding to the PWM signal. The analog signal is then sent to the laser drive assembly 105, making the laser drive assembly 105 generate the light source drive signal based on the analog signal and the enable signal. In this case, the synchronization signal sent to the bias voltage conversion circuit 711 (or named the phase light modulation assembly 107) may include the enable signal and the PWM signal. It is understood that the bias voltage conversion circuit 711 may also not include the DAC 7115, and the synchronization signal sent to the phase light modulation assembly 107 may only include the enable signal.

In this embodiment, the phase light modulation assembly 107 may include the modulating light drive assembly 1071 and the phase light modulator 1072. The modulating light drive assembly 1071 may include the modulating light drive circuit 710 and the bias voltage conversion circuit 711. The bias voltage conversion circuit 711 is configured to send the bias voltage to the phase light modulator 1072 based on the enable signal. The modulating light drive circuit 710 is configured to drive the one or more micro-mirrors 1031 of the phase light modulator 1072 to move under the action of the bias voltage, based on the synchronization signal and the phase video signal, in order to achieve the phase modulation. This enables spatial redistribution of light energy when achieving local backlight modulation, thereby increasing peak brightness and reducing dark-field brightness.

In a possible implementation, FIG. 14 is a schematic structural diagram of another bias voltage conversion circuit 711 provided according to an embodiment of the present disclosure. Referring to FIG. 14, the bias voltage conversion circuit 711 may include a control assembly 7114, the DAC 7115, and an amplifier 7116.

The control assembly 7114 is connected to the DAC 7115. For example, the control assembly 7114 and the DAC 7115 may be connected via an Inter-Integrated Circuit (I2C) bus or a Serial Peripheral Interface (SPI) bus, etc. Connection via the SPI bus may improve connection efficiency, and the present disclosure does not limit the connection method between the control assembly 7114 and the DAC 7115.

The control assembly 7114 is configured to input the target voltage to DAC 7115. The DAC 7115 is configured to convert the target voltage into an analog voltage signal. The amplifier 7116 is connected to the DAC 7115 and the phase light modulator 1072, respectively. The amplifier 7116 is configured to send the bias voltage to the phase light modulator 1072 based on the analog voltage signal. In this way, through adjusting the target voltage input to the DAC 7115 by the control assembly 7114, the bias voltage sent by the amplifier 7116 to the phase light modulator 1072 may be adjusted.

When the bias voltage conversion circuit 711 is applied to the laser projection device shown in FIG. 7 and FIG. 10, referring to FIG. 14, the control assembly 7114 is also connected to the display drive assembly 102. The display drive assembly 102 is specifically configured to send the enable signal to the control assembly 7114. The control assembly 7114 is configured to input the target voltage corresponding to the primary color light to the DAC 7115 based on the enable signal. The DAC 7115 is configured to convert the target voltage corresponding to the primary color light into the voltage analog signal. The amplifier 7116 is configured to send the bias voltage to the phase light modulator 1072 based on the voltage analog signal.

In a possible implementation, the bias voltage conversion circuit 711 may further include four resistors 7117 and one capacitor 7118. The structure of four resistors 7117 and one capacitor 7118 is required circuit structure. The specific connection of the amplifier 7116 with four resistors 7117 and one capacitor 7118 may be referred to in FIG. 14.

In a possible implementation, if a digital-to-analog conversion function is integrated into the control assembly 7114, the control assembly 7114 is also configured to perform digital-to-analog conversion on the target voltage to obtain the voltage analog signal, and send the voltage analog signal to the amplifier 7116 through a DA interface, such that the amplifier 7116 is configured to send the bias voltage to the phase light modulator 1072 based on the voltage analog signal.

In a possible implementation, the control assembly 7114 may be a Microcontroller Unit (MCU).

For example, the control assembly 7114 may receive the enable signal corresponding to the red primary light, the green primary light, and the blue primary light (i.e., R_EN, G_EN, and B_EN) through interrupt ports IN1, IN2, and IN3, respectively, such that the control assembly 7114 outputs three different target voltages to input voltage analog signals to the amplifier 7116. The amplifier 7116 may achieve voltage range adjustment. For example, when the target voltage is low, an amplification factor of the amplifier 7116 is less than 1 to improve control accuracy and input the bias voltage to the phase light modulator 1072.

Since a target voltage value is converted by the DAC 7115 and amplified by the amplifier 7116, errors are easily introduced. The following voltage correction may be performed. In a possible embodiment, the amplifier 7116 is connected to the control assembly 7114. The amplifier 7116 is further configured to send the bias voltage to the control assembly 7114. The control assembly 7114 is further configured to perform the voltage correction on target voltages corresponding to subsequent primary color lights based on the bias voltage.

Specifically, the amplifier 7116 may be connected to an AD interface of the control assembly 7114 to input the bias voltage to the AD interface. The control assembly 7114 may calculate a voltage deviation based on a voltage value received by the AD interface and a voltage value of the bias voltage required for a current primary color light. Then, based on this difference value of voltage, the voltage correction may be performed on the target voltage corresponding to a subsequent primary color light. The bias voltage required for the current primary color light may be understood as a set bias voltage or a standard bias voltage.

For example, if the bias voltage required for the current primary light is 1.15V, and the voltage value received by the control assembly 7114 based on the AD interface is 1.14V, then there is a voltage deviation of 0.01V. The control assembly 7114 may increase the target voltage corresponding to the subsequent primary light by 0.01V. For example, if the bias voltage required for the subsequent primary light is 1.18V (the target voltage for this primary light is 1.18V), the target voltage corresponding to this primary light may be increased by 0.01V (i.e., 1.19V) to compensate for 0.01V loss after conversion by the DAC and amplification by the amplifier 7116, in order to make the bias voltage input to the phase light modulator 1072 be 1.18V as required.

A voltage deviation between the voltage value output by the amplifier 7116 and the target voltage is configured to determine an error introduced by the voltage value after the conversion by the DAC and the amplification by the amplifier 7116. The bias voltage of the subsequent primary color light is corrected based on the error to achieve closed-loop control and improve an accuracy rate of the bias voltage input to the phase light modulator 1072.

For example, FIG. 15 is a schematic diagram of a waveform diagram of the enable signal and the bias voltage. FIG. 15 is a waveform diagram in the absence of a delay. VBIAS represents the bias voltage, RED_EN represents an enable signal corresponding to the red primary light, GREEN_EN represents an enable signal corresponding to the green primary light, and BLUE_EN represents an enable signal corresponding to the blue primary light. Since a certain amount of time is taken for the voltage value to be converted by the DAC and amplified by the amplifier 7116 after the control assembly 7114 receives the enable signal. In order to synchronize output of the enable signal by the display drive assembly 102 and output of the bias voltage by the amplifier 7116, a delay of subsequent output of the enable signal corresponding to the primary light may be adjusted in the following methods.

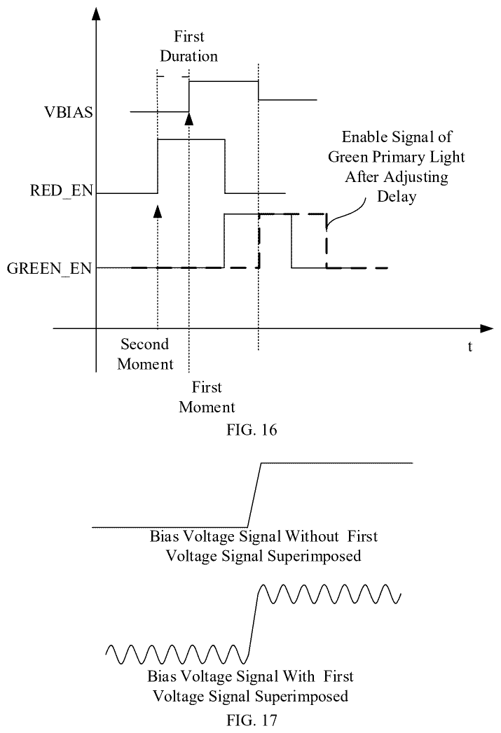

In a possible implementation, referring to FIG. 16, a first moment of the amplifier 7116 outputting the bias voltage corresponding to the current primary light, and a second moment of the display drive assembly 102 outputting the enable signal corresponding to the current primary light, are determined. First duration is determined based on the first moment and the second moment, and output of the enable signal corresponding to the subsequent primary light is time-adjusted based on the first duration, thereby achieving synchronization.

Specifically, the control assembly 7114 is configured to receive, at pin INT4, an input/output (IO) level signal converted by a voltage conversion and a Schmitt trigger combination (a triangle symbol in FIG. 14) . The IO level signal is generated based on the bias voltage output by the amplifier, and the control assembly may determine the first moment based on the IO level signal.

For example, for ease of understanding, taking the current primary color light as the red primary color light and the subsequent primary color light as the green primary color light as an example, FIG. 16 is a schematic diagram of adjusting a delay of the enable signal corresponding to the subsequent primary color light in a case of existing a delay.

Furthermore, because the bias voltage controls a height of each of the one or more micro-mirrors 1031 of the phase light modulator 1072, different wavelengths of relevant light waves correspond to different bias voltages. Within a certain bias voltage range, slight changes in a voltage cause slight changes in the height of each of the one or more micro-mirrors 1031. These slight changes in the height may cause changes in a position of a coherent speckle, thereby forming a speckle.

To further reduce the speckle, in a possible implementation, the bias voltage is adjusted based on the first voltage signal to obtain a processed bias voltage, and the processed bias voltage is sent to the phase light modulator 1072. The first voltage signal is configured to control the bias voltage to vary within a range of the target voltage.

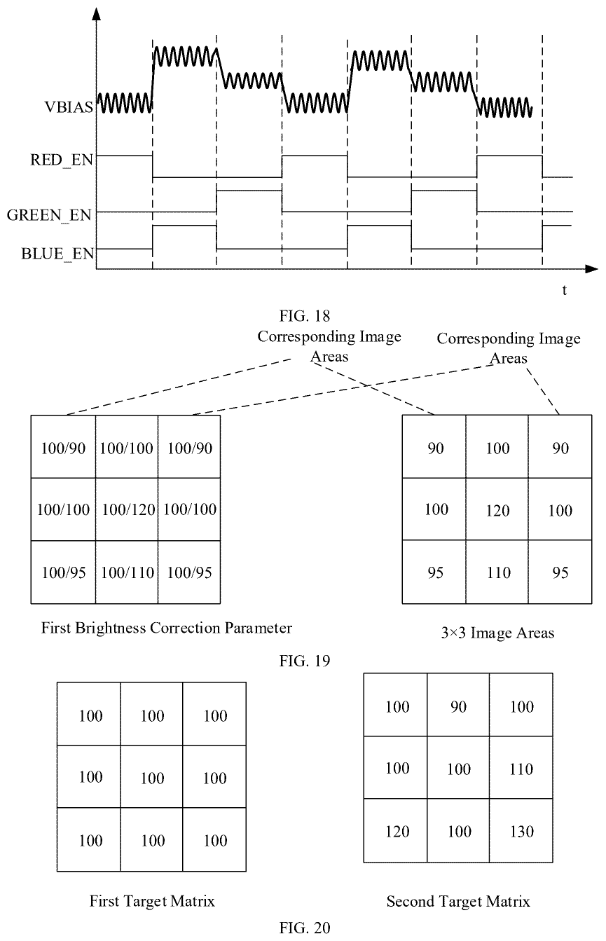

It may be understood that the bias voltage is sent to the phase light modulator 1072 in a form of a continuous signal. That is, the bias voltage received by the phase light modulator 1072 may be referred to as a bias voltage signal. Specifically, the control assembly is further configured to output the first voltage signal, and the amplifier 7116 is specifically configured to superimpose the first voltage signal with the bias voltage signal to obtain a processed bias voltage signal. For example, referring to FIG. 17, FIG. 17 is a schematic diagram of the bias voltage signal without and with the first voltage signal superimposed. The processed bias voltage signal is input into the phase light modulator 1072 to drive the one or more micro-mirrors 1031 of the phase light modulator 1072 to vibrate slightly, and corresponding diffraction image speckle is rapidly displaced. Speckle contrast is reduced through time integration to achieve speckle reduction. FIG. 18 is a schematic diagram of waveforms of the bias voltage signal superimposed on the first voltage signal and the enable signal.

In a possible implementation, the display drive assembly 102 may send a control signal to the control assembly 7114. The control signal may be configured to control operating modes of the control assembly 7114. For example, whether to superimpose the first voltage signal, or specify the control assembly 7114 to perform speckle removal processing on one or more colors of the three primary colors, as well as the amplitude and frequency of the speckle removal waveform, etc.

In the following, how the video processing assembly 106 determines the phase video signal based on the video signal is described in detail.

In a possible implementation, the video processing assembly 106 may generate a phase video signal based on the video signal sent by the main control chip 101.

Specifically, the video processing assembly 106 may obtain multiple sub-video signals, and each of the multiple sub-video signals is generated based on the video signal. The specific implementation may refer to the above embodiments. For any one of the multiple sub-video signals, brightness information of multiple sub-images corresponding to each of the multiple sub-video signals is obtained, and phase image information corresponding to each of the multiple sub-video signals is generated based on the brightness information of the multiple sub-images. The phase video signal is generated based on the phase image information corresponding to each of the multiple sub-video signals.

In another possible implementation, the video processing assembly 106 may obtain a brightness correction parameter, and generate the phase video signal based on the brightness correction parameter and the video signal.

Specifically, the video processing assembly 106 may obtain the multiple sub-video signals. For any one of the multiple sub-video signals, brightness information of multiple sub-images corresponding to each of the multiple sub-video signals is obtained, and phase image information corresponding to each of the multiple sub-video signals is generated based on the brightness information of the multiple sub-images and the brightness correction parameter. The phase video signal is generated based on the phase image information corresponding to each of the multiple sub-video signals. For example, the brightness information may be a brightness value.

The brightness correction parameter may include first brightness correction parameters corresponding to multiple colors. That is, a first brightness correction parameter corresponding to R, a first brightness correction parameter corresponding to G, and a first brightness correction parameter corresponding to B. For example, taking R as an example, the first brightness correction parameter corresponding to R refers to FIG. 19. FIG. 19 illustrates dividing an image into 3×3 image areas, with each number representing a brightness compensation parameter for one image area.

For example, for any one of sub-images from the R sub-video signal, referring to FIG. 19, the sub-image is divided into 3×3 image areas, and then brightness information of each of the image areas is calculated. The number of each of the image areas represents a brightness value in the figure. In a possible implementation, brightness information of a center point of each of the image areas is obtained, and brightness information of each of the image areas is represented by the brightness information of the center point.

After obtaining the brightness information of each of the image areas, brightness compensation parameters for corresponding areas may be obtained. For example, by multiplying the brightness information of image area 1 with the brightness compensation parameter of the corresponding image area (i.e., image area 1) in FIG. 19, brightness of a low-brightness image area is increased, while brightness of a high-brightness image area is decreased. Some of the light is shifted from a center area to a corner, adjusting intensity distribution of the illumination beam, thereby compensating for brightness of a darker area in the image and improving brightness uniformity of a final displayed image.

In the following, a detailed introduction is provided on how to obtain the brightness correction parameter.

In a possible implementation, the video processing assembly 106 is further configured to obtain brightness information of first images corresponding to multiple color image cards, and determine a brightness correction parameter based on the brightness information of the first images corresponding to the multiple color image cards.

The video processing assembly 106 may store the brightness correction parameter for generating the phase video signal.

For example, the video processing assembly 106 may receive a first image sent by a brightness measurement device. The brightness measurement device may be a device with a specific shooting function or a device such as a brightness meter. The type of equipment of the brightness measurement device is not limited to the present disclosure.

In a possible implementation, the video processing assembly 106 is specifically configured to: for a first image corresponding to any one of the multiple color image cards, divide the first image into multiple image areas; for any one of the multiple image areas, obtain first brightness information of each of the multiple image areas; determine brightness compensation parameters corresponding to the multiple image areas based on the first brightness information corresponding to the multiple image areas; and determine a first brightness correction parameter corresponding to the color image card based on the brightness compensation parameters corresponding to the multiple image areas.

Specifically, for the operation of determining brightness compensation parameters corresponding to the multiple image areas based on the first brightness information corresponding to the multiple image areas, the video processing assembly 106 is specifically configured to obtain a target matrix. For any value in the target matrix, the value is divided by the first brightness information of an image area corresponding to the value, in order to obtain the brightness compensation parameter corresponding to the image area.

In a possible implementation, the target matrix may be determined based on an average value of the first brightness information of the multiple image areas. It is understood that the value of the target matrix may be a target parameter for uniform brightness distribution. For example, a first target matrix is shown in FIG. 20.

In a possible implementation, the target matrix may also include different target parameters. A target parameter corresponding to a darker image area and a target parameter corresponding to a brighter image area may be different, in order to achieve local brightness adjustment. For example, a second target matrix is shown in FIG. 20.

For example, a pure color image card may be projected onto a projection screen by the laser projection device 1, and the brightness measurement device may capture the pure color image card to obtain a first image. Then, the video processing assembly 106 may divide the first image into multiple image areas. For example, the first image may be divided into 9 image areas, 16 image areas, or more. The more image areas there are, the more refined correction to the image's brightness uniformity may be made.

For any image area, for example, brightness information of the center point of the image area may be obtained, and then the brightness information of the center point may be represented as the brightness information of the image area. The center point may be a central pixel point of the image area, and the number of the central pixel points may be one or more. The number of the central pixel points is not limited in the present disclosure.

It may be understood that a pure color image card of red may obtain a first brightness correction parameter, a pure color image card of green may obtain a first brightness correction parameter, and a pure color image card of blue may obtain a first brightness correction parameter. The brightness adjustment assembly 109 may determine that the brightness correction parameter may include first brightness correction parameters corresponding to multiple colors. That is, a first brightness correction parameter corresponding to red, a first brightness correction parameter corresponding to green, and a first brightness correction parameter corresponding to blue.

In a possible implementation, after the brightness correction parameters are obtained, the brightness correction parameters are verified. That is, the first brightness correction parameter corresponding to red, the first brightness correction parameter corresponding to green, and the first brightness correction parameter corresponding to blue are verified, respectively.

Specifically, for a first brightness correction parameter corresponding to any one of the multiple color image cards, determine whether the first brightness correction parameter meets a preset condition. If it is not satisfied, the first brightness correction parameter for the pure color image card is adjusted to obtain a second brightness correction parameter satisfying the preset condition. If it is satisfied, the first brightness correction parameter corresponding to the color image card is used as the second brightness correction parameter.

That is, for the first brightness correction parameter that does not meet the preset condition, the first brightness correction parameter needs to be corrected to obtain a corrected brightness correction parameter. That is, the second brightness correction parameter. For the first brightness correction parameter that meets the preset condition, no correction is required, and the first brightness correction parameter corresponding to the color image card is used as the second brightness correction parameter. That is, the first brightness correction parameter is equal to the second brightness correction parameter.

The preset condition is that brightness of the first image after brightness correction is performed based on the first brightness correction parameter is uniformly distributed.

Taking the first brightness correction parameter corresponding to red as an example, the brightness of the first image corresponding to a red image card is corrected based on the first brightness correction parameter. Determine that a corrected first image is then divided into multiple image areas. Brightness information of each of the multiple image areas is determined, and then a difference value between brightness values of any two of the multiple image areas is calculated. If the difference value is less than a preset threshold, brightness distribution of the first image after brightness correction is determined to be uniform.

In a possible implementation, the first brightness correction parameter is corrected as follows.

Exemplarily, for the first brightness correction parameter corresponding to any color image card, for example, when the video processing assembly 106 generates the first brightness correction parameter, it divides the first image corresponding to the color image card into 9 image areas.

Then, for correction of the first brightness correction parameter, the video processing assembly 106 is specifically configured to:
divide the first image corresponding to the color image card into 16 image areas; for any one of the multiple image areas, obtain third brightness information of the image area, and determine a brightness compensation parameter corresponding to the image area based on the third brightness information. A corrected first brightness correction parameter may be determined based on the brightness compensation parameters corresponding to the multiple image areas.

In this embodiment, the video processing assembly 106 may determine the first brightness correction parameters corresponding to different colors, based on the first images corresponding to three color pure color image cards. Thus, after the video signal is subsequently decomposed into the R sub-video signal, the G sub-video signal, and the B sub-video signal, for example, first-level brightness correction parameter corresponding to R may be used to perform brightness compensation on the R sub-image corresponding to the R sub-video signal, and then the phase image information corresponding to R is generated based on a brightness-compensated R sub-image, thereby improving the brightness uniformity of the final displayed image.

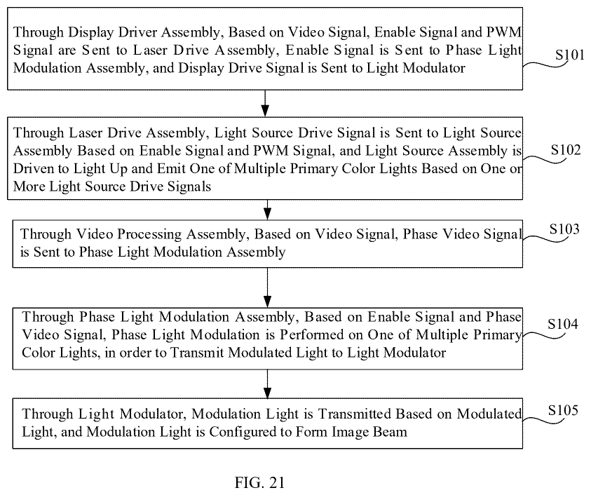

FIG. 21 is a schematic flow of an image display method for the laser projection device provided according to an embodiment of the present disclosure. The structure of the laser projection device may refer to the above embodiments. Referring to FIG. 21, the method may include the following steps:
S101: through a display drive assembly, based on a video signal, an enable signal and a PWM signal are sent to a laser drive assembly, the enable signal is sent to the phase light modulation assembly, and a display drive signal is sent to a light modulator.
S102: through the laser drive assembly, a light source drive signal is sent to a light source assembly based on the enable signal and the PWM signal, and the light source assembly is driven to light up and emit one of multiple primary color lights based on the light source drive signal.
S103: through a video processing assembly, based on the video signal, a phase video signal is sent to the phase light modulation assembly.
S104: through the phase light modulation assembly, based on the enable signal and the phase video signal, phase light modulation is performed on one of the multiple primary color lights, in order to transmit modulated light to the light modulator.
S105: through the light modulator, a modulation light is transmitted based on the modulated light, and the modulation light is configured to form an image beam.

In a possible implementation, step 104 may include the following steps: through the phase light modulation assembly, a bias voltage is determined based on the enable signal, and the phase light modulation is performed on the one of the multiple primary color lights based on the phase video signal and the bias voltage to transmit the modulated light to the light modulator.

The present disclosure further provides a computer-readable memory medium, and the computer-readable memory medium may include: a USB flash drive, a mobile hard disk, a Read-Only Memory (ROM), a Random Access Memory (RAM), a disk or an optical disk, and various other media that may store program codes. Specifically, the computer-readable memory medium stores program instructions, and the program instructions are configured to implement the method in the above embodiments.

The present disclosure further provides a program product, and the program product may include execution instructions stored in a readable storage medium. At least one control module of a display equipment may read the execution instructions from the readable storage medium, and at least one control module executes the execution instructions to cause the display equipment to implement the method provided in the various embodiments described above.

The above descriptions are merely optional embodiments of the present disclosure and are not intended to limit the present disclosure. Any modifications, equivalent replacements, improvements, etc., made within the principles of the present disclosure should be included in the scope of protection of the present disclosure.

What is claimed is:

1. A laser projection device, comprising:
a main control chip configured to generate a video signal based on an external video source;
a light source assembly;
a laser drive assembly connected to the light source assembly;
a light modulator;
a display drive assembly connected to the laser drive assembly and the light modulator, respectively, and configured to obtain the video signal, send an enable signal and a Pulse Width Modulation (PWM) signal to the laser drive assembly based on the video signal, and send a display drive signal to the light modulator based on the video signal; wherein the laser drive assembly is configured to send a light source drive signal to the light source assembly based on the enable signal and the PWM signal, in order to drive the light source assembly to light up and emit one of a plurality of primary color lights;
a phase light modulation assembly connected to the display drive assembly; wherein the display drive assembly is further configured to send the enable signal to the phase light modulation assembly; and
a video processing assembly connected to the main control chip and the phase light modulation assembly, respectively, and configured to send a phase video signal to the phase light modulation assembly based on the video signal; wherein the phase light modulation assembly is configured to perform a phase light modulation based on the phase video signal and the enable signal to transmit a modulated light to the light modulator;
wherein the light modulator is configured to transmit a modulation light based on the modulated light, and the modulation light is configured to form an image beam.

2. The laser projection device of claim 1, wherein the phase light modulation assembly comprises:
a phase light modulator configured to perform the phase light modulation based on the phase video signal and a bias voltage, in order to transmit the modulated light to the light modulator; and
a modulating light drive assembly electrically connected to the video processing assembly, the display drive assembly, and the phase light modulator, respectively, and configured to determine the bias voltage of the phase light modulator based on the enable signal and send the phase video signal and the bias voltage to the phase light modulator;
wherein the video processing assembly is configured to send the phase video signal to the modulating light drive assembly;
wherein the display drive assembly is configured to send the enable signal to the modulating light drive assembly.

3. The laser projection device of claim 2, wherein the phase light modulator is configured to control displacement of one or more micro-mirrors of the phase light modulator based on the bias voltage, in order to perform a phase modulation on the one of the plurality of primary color lights by means of the one or more micro-mirrors after the displacement.

4. The laser projection device of claim 2, wherein the phase light modulator is configured to:
adjust step lengths of displacement of one or more micro-mirrors of the phase light modulator based on the bias voltage; and
perform a phase modulation on the one of the plurality of primary color lights by means of one or more adjusted micro-mirrors.

5. The laser projection device of claim 2, wherein a timing of the phase light modulator receiving the phase video signal is consistent with a timing of the light modulator receiving the display drive signal.

6. The laser projection device of claim 2, wherein a display duration of a video signal corresponding to a target primary color of a target frame displayed by the light modulator overlaps, at least in part, with a display duration of a phase video signal corresponding to the target primary color of the target frame displayed by the phase light modulator.

7. The laser projection device of claim 2, wherein the modulating light drive assembly comprises:
a modulating light drive circuit connected to the video processing assembly and the phase light modulator, and configured to send the phase video signal to the phase light modulator based on the enable signal, wherein the video processing assembly is configured to send the phase video signal to the modulating light drive assembly; and
a bias voltage conversion circuit connected to the phase light modulator, and configured to send the bias voltage to the phase light modulator based on the enable signal;
wherein the display drive assembly is connected to the modulating light drive circuit and the bias voltage conversion circuit, respectively; wherein the display drive assembly is configured to send the enable signal to the modulating light drive circuit and the bias voltage conversion circuit.

8. The laser projection device of claim 7, wherein the bias voltage conversion circuit further comprises:
a Digital-to-Analog Converter (DAC) connected to the display drive assembly and the laser drive assembly, respectively, and configured to perform a digital-to-analog conversion on the PWM signal to obtain an analog signal corresponding to the PWM signal, and send the analog signal to the laser drive assembly;
wherein the display drive assembly is configured to send the PWM signal to the DAC; wherein the analog signal and the enable signal are configured to generate the light source drive signal.

9. The laser projection device of claim 7, wherein the bias voltage conversion circuit comprises:
a plurality of voltage regulators, wherein each of the plurality of voltage regulators corresponds to a different target voltage; and
an analog selection switch connected to the plurality of voltage regulators, the display drive assembly, and the phase light modulator, respectively, and configured to, based on the enable signal, determine the bias voltage from target voltages corresponding to the plurality of primary color lights, and send the bias voltage to the phase light modulator;
wherein the plurality of voltage regulators are configured to send the target voltages corresponding to the plurality of primary color lights to the analog selection switch; wherein the display drive assembly is configured to send the enable signal to the analog selection switch.

10. The laser projection device of claim 9, wherein the laser projection device further comprises a power supply; and
the bias voltage conversion circuit further comprises:
a direct current converter connected to the power supply and the plurality of voltage regulators, respectively, and configured to input a first voltage to the plurality of voltage regulators respectively based on a drive voltage input by the power supply;
wherein each voltage regulator of the plurality of voltage regulators is configured to input a target voltage corresponding to the voltage regulator to the analog selection switch based on the first voltage.

11. The laser projection device of claim 7, wherein the bias voltage conversion circuit comprises:
a Digital-Analog Converter (DAC) configured to convert a target voltage into a voltage analog signal;
a control assembly connected to the display drive assembly and the DAC, respectively, and configured to input the target voltage corresponding to a primary color light indicated by the enable signal to the DAC based on the enable signal; wherein each of the plurality of primary color lights corresponds to a different target voltage; wherein the display drive assembly is configured to send the enable signal to the control assembly; and
an amplifier connected to the DAC and the phase light modulator, respectively, and configured to send the bias voltage to the phase light modulator based on the voltage analog signal.

12. The laser projection device of claim 11, wherein the control assembly receives enable signals corresponding to the plurality of primary color lights sent by the display drive assembly through a plurality of interrupt ports, respectively.

13. The laser projection device of claim 11, wherein the amplifier is further connected to the control assembly, and is further configured to send the bias voltage to the control assembly;
wherein the control assembly is further configured to correct the target voltage sent to the DAC based on a difference value between the bias voltage that is received sent by the amplifier and a set bias voltage.

14. The laser projection device of claim 11, wherein the control assembly is configured to output a first voltage signal to the amplifier;
wherein the amplifier is further connected to the control assembly, and is further configured to obtain a processed bias voltage signal by superimposing the first voltage signal with a bias voltage signal, and send the processed bias voltage signal to the phase light modulator;
wherein the bias voltage signal comprises a continuous bias voltage, and the first voltage signal is configured to control the bias voltage to vary within a range of the target voltage.

15. The laser projection device of claim 1, wherein the video processing assembly is configured to:
acquire a plurality of sub-video signals; wherein the plurality of sub-video signals are obtained based on the video signal that is decoded; wherein the plurality of sub-video signals correspond to a plurality of primary colors, respectively;
for each sub-video signal of the plurality of sub-video signals, determine a phase information signal corresponding to the sub-video signal; and
determine the phase video signal based on the phase information signals corresponding to the plurality of sub-video signals.

16. The laser projection device of claim 2, wherein the video processing assembly is configured to:
obtain a first resolution of the phase light modulator; and
perform a pixel compression on an image with a resolution higher than the first resolution from the video signal, based on the first resolution, such that the resolution of a compressed image matches the first resolution.

17. The laser projection device of claim 1, wherein the video processing assembly is connected to the display drive assembly, and the display drive assembly is configured to receive the video signal sent by the video processing assembly.

18. The laser projection device of claim 1, wherein the main control chip is connected to the display drive assembly, and the display drive assembly is configured to receive the video signal sent by the main control chip.

19. The laser projection device of claim 1, wherein the video processing assembly is configured to:
acquire a plurality of sub-video signals, wherein the plurality of sub-video signals are obtained based on decoding the video signal; wherein the plurality of sub-video signals correspond to a plurality of primary colors;
acquire brightness information of a plurality of sub-images from each of the plurality of sub-video signals, and generate a phase image information corresponding to each of the plurality of sub-video signals based on the brightness information and brightness correction parameters of the plurality of sub-images; and
generate the phase video signal based on the phase image information corresponding to the plurality of sub-video signals.

20. A method for image display of a laser projection device, the laser projection device comprising:
a main control chip, a display drive assembly, a light modulator, a light source assembly, a laser drive assembly, a phase light modulation assembly, and a video processing assembly;
wherein the display drive assembly is connected to the laser drive assembly, the light modulator, and the phase light modulation assembly, respectively; wherein the laser drive assembly is connected to the light source assembly; wherein the video processing assembly is connected to the main control chip and the phase light modulation assembly, respectively; and
the method comprising:
acquiring, by the display drive assembly, a video signal, sending an enable signal and a Pulse Width Modulation (PWM) signal to the laser drive assembly based on the video signal, sending the enable signal to the phase light modulation assembly, and sending a display drive signal to the light source assembly based on the video signal;
sending, by the laser drive assembly, a light source drive signal to the light source assembly based on the enable signal and the PWM signal, in order to drive the light source assembly to light up and emit one of a plurality of primary color lights;
sending, by the video processing assembly, a phase video signal to the phase light modulation assembly based on the video signal;
performing, by the phase light modulation assembly, a phase light modulation based on the phase video signal and the enable signal, in order to transmit a modulated light to the light modulator; and
transmitting, by the light modulator, a modulation light based on the modulated light, wherein the modulation light is configured to form an image beam.
